(19) United States
(12) Patent Application Publication
(10) Pub. No.: US 2018/0349854 A1
(43) Pub. Date: Dec. 6, 2018

(54) SYSTEMS AND METHODS FOR MONITORING AND REPORTING MOBILE DEVICE ACTIVITY

(71) Applicant: Teleo Group, LLC, Anaheim, CA (US)

(72) Inventors: Sean Wayne Wigand, Lake Forest, CA (US); Thomas Chow Ling, Yorba Linda, CA (US)

(21) Appl. No.: 15/977,232

(22) Filed: May 11, 2018

Related U.S. Application Data
(60) Provisional application No. 62/505,290, filed on May 12, 2017.

(51) Int. Cl. G06Q 10/10; H04L 29/08; H04W 4/029; G06F 3/0488

(52) U.S. Cl. CPC G06Q 10/1091; G06F 3/04886; H04W 4/029; H04L 67/22

(57) ABSTRACT

A system and method is provided for use with a mobile electronic device (e.g., mobile phone, such as a smartphone) that tracks the amount of time the mobile electronic device is used by the user (e.g., employee) during a period of time (e.g., during a work shift at a workplace) to minimize or eliminate distractions from said mobile electronic device in order to improve the efficiency of the user (e.g., employee). The system and method provides a quantitative analysis of the efficiency of the user during said period of time and/or a quantitative analysis of the number of times the user (e.g., employee) interacts with their phone (e.g., during a work period).

### CROSS-REFERENCE TO RELATED APPLICATIONS

Any and all applications for which a foreign or domestic priority claim is identified in the application data sheet as filed with the present application are hereby incorporated by reference under 37 CFR 1.57 in their entirety and should be considered a part of this specification.

### BACKGROUND

### Field

This invention relates to the monitoring and reporting of mobile device activity.

### Description of the Related Art

Use of mobile electronic devices, such as mobile phones, is common-place and allow users ready access to a wealth of information, as well as allow ready interaction with others via text messages, social media and other mobile applications software (or “apps”).

For example, mobile applications software (or “apps”) that operate on smartphones, tablet computers, wearable electronics and other mobile electronic devices have become increasingly popular. With the explosion in the number and variety of mobile applications, people are spending more time using mobile applications on their mobile devices. Indeed, mobile phone use can become so routine that users may not be conscious of how much time they spend using their phone (e.g., using a web browser, watching video, or using apps, such as social media apps). In yet other examples, artificial intelligence and internal electronic devices or electronic augmentations to humans that will allow BCI (brain-computer interface), retinal or other human interactions with electronics.

However, mobile phone use can be distracting, and interrupt daily life activities of the user. Further, excessive use of electronics or mobile apps may create numerous health hazards, including accidents, injury while operating machinery, increased level of procrastination, and other associated problems. In particular, frequent and abundant updates from apps such as social media and text message applications are particularly notorious in distracting people from engaging in work, study, or otherwise productive activities. Indeed, concerns over screen addiction have attracted attention from various health authorities and researchers.

### SUMMARY

In view of the growing ubiquity of mobile communication devices, there is an increasing need to monitor their use. For example, users want to be better aware of (e.g., quantitatively measure) their own mobile communication device usage. In addition, to improve safety and efficiency, there is a need for employers to know their employees' mobile phone usage habits during work hours.

In accordance with one aspect of the invention, an app is provided for use on a mobile electronic device (e.g., mobile phone, such as a smart phone) that tracks the amount of time the mobile electronic device is used by the user during a period of time (e.g., during a work shift at a workplace) and provides a quantitative analysis of the efficiency of the user during said period of time. The app advantageously serves to minimize or eliminate distractions from said electronics and/or apps to thereby improve the efficiency of the user (e.g., while at work).

In accordance with one aspect of the invention, a computer implemented method for monitoring and reporting mobile phone use while at work is provided. The method comprises receiving a first touch input to a first display object in a graphical user interface of an app displayed on a mobile electronic device indicative of a clock-in time of a work period and initiating a work time counter in response to said first touch input to track a period of time. The method also comprises recording one or more break periods upon receiving on a second display object in the graphical user interface on the mobile electronic device a second touch input indicative of a break start time and a third time input indicative of a break end time, said second touch input initiating a break time counter and said third touch input stopping said break time counter. The method also comprises stopping the work time counter in response to said second touch input and resuming the work time counter in response to said third touch input. The method also comprises identifying one or more user interaction events during which the user interacts with the mobile electronic device so that the app changes to a background state and recording a user interaction time period for each of the one or more user interaction events. The method also comprises receiving a fourth touch input to the first display object in the graphical user interface indicative of a clock-out time for the work period. The method also comprises calculating an efficiency score for the user over a transpired time period by subtracting from the transpired time period the one or more break periods measured from the break start time to the break end time, and subtracting from the transpired time period the one or more user interaction time periods.

The method may optionally be arranged such that identifying the one or more user interaction periods comprises setting a screen timeout period for the graphical user interface of the mobile electronic device, monitoring interactions between the user and the mobile electronic device and restarting a counter every time the user interacts with the mobile electronic device, identifying with a timestamp when the app transitions to the background state, recording an elapsed time period from a timestamp for the last user interaction with the mobile electronic device and the timestamp for the transition to the background state, recording as a user interaction period the recorded elapsed time period if the elapsed time period is less than the screen timeout period, increasing the screen timeout period by a first amount if said elapsed time period is greater than a previously recorded screen timeout period, and resetting the screen timeout period to the elapsed time if said elapsed time period is recorded for a plurality of consecutive monitored interactions.

In accordance with another aspect of the invention, a system for monitoring and reporting mobile phone use while at work is provided. The system comprises one or more computing devices including one or more processors, one or more memory devices, and one or more network interface devices. The system also comprises a web server application stored in the one or more memory devices and executable by the one or more processors to receive, process, and respond to data requests received via the one or more network interface devices from an app on a mobile electronic device. The one or more processors are operable to perform operations comprising receiving a first touch input to a first display object in a graphical user interface of an app displayed on a mobile electronic device indicative of a clock-in time of a work period, initiating a work time counter in response to said first touch input to track a period of time, recording one or more break periods upon receiving on a second display object in the graphical user interface on the mobile electronic device a second touch input indicative of a break start time and a third time input indicative of a break end time, said second touch input initiating a break time counter and said third touch input stopping said break time counter, stopping the work time counter in response to said second touch input and resuming the work time counter in response to said third touch input, identifying one or more user interaction events during which the user interacts with the mobile electronic device so that the app changes to a background state and recording a user interaction time period for each of the one or more user interaction events, receiving a fourth touch input to the first display object in the graphical user interface indicative of a clock-out time for the work period, and calculating an efficiency score for the user over a transpired time period by subtracting from the transpired time period the one or more break periods measured from the break start time to the break end time, and subtracting from the transpired time period the one or more user interaction time periods.

The system may optionally be arranged such that identifying the one or more user interaction time periods comprises setting a screen timeout period for the graphical user interface of the mobile electronic device, monitoring interactions between the user and the mobile electronic device and restarting a counter every time the user interacts with the mobile electronic device, identifying with a timestamp when the app transitions to the background state, recording an elapsed time period from a timestamp for the last user interaction with the mobile electronic device and the timestamp for the transition to the background state, recording as a user interaction period the recorded elapsed time period if the elapsed time period is less than the screen timeout period, increasing the screen timeout period by a first amount if said elapsed time period is greater than a previously recorded screen timeout period, and resetting the screen timeout period to the elapsed time if said elapsed time period is recorded for a plurality of consecutive monitored interactions.

In accordance with another aspect of the invention, a computer program product for monitoring and reporting mobile phone use while at work is provided. The computer program product is stored on a computer readable medium comprising instructions that when executed on a server cause the server to perform operations comprising receiving a first touch input to a first display object in a graphical user interface indicative of a clock-in time of a work period, the first display object being associated with an app interface on a mobile electronic device, initiating a work time counter in response to said first touch input to track a period of time, recording one or more break periods upon receiving on a second display object in the graphical user interface a second touch input indicative of a break start time and a third time input indicative of a break end time, the second display object being associated with the app interface on the mobile electronic device, said second touch input initiating a break time counter and said third touch input stopping said break time counter, stopping the work time counter in response to said second touch input and resuming the work time counter in response to said third touch input, identifying one or more user interaction events indicative of user interaction with the mobile electronic device when the app interface on the mobile electronic device transitions to a background state, recording a user interaction time period for each of the one or more user interaction events, receiving a fourth touch input to the first display object in the graphical user interface indicative of a clock-out time for the work period, and calculating an efficiency score for the user over a transpired time period by subtracting from the transpired time period the one or more break periods measured from the break start time to the break end time, and subtracting from the transpired time period the one or more user interaction time periods.

The computer program product may optionally be arranged such that identifying the one or more user interaction time periods comprises setting a screen timeout period for the graphical user interface of the mobile electronic device, monitoring interactions between the user and the mobile electronic device and restarting a counter every time the user interacts with the mobile electronic device, identifying with a timestamp when the app transitions to the background state, recording an elapsed time period from a timestamp for the last user interaction with the mobile electronic device and the timestamp for the transition to the background state, recording as a user interaction period the recorded elapsed time period if the elapsed time period is less than the screen timeout period, increasing the screen timeout period by a first amount if said elapsed time period is greater than a previously recorded screen timeout period, and resetting the screen timeout period to the elapsed time if said elapsed time period is recorded for a plurality of consecutive monitored interactions.

### BRIEF DESCRIPTION OF THE DRAWINGS

FIG. 1 is a logical diagram illustrating interactions between different components of a mobile application software (an “app”) for monitoring use of a mobile electronic device.

FIGS. 2A-2G are schematic diagrams of an example user interface on the mobile electronic device during use of the app.

FIG. 3 is a flow chart illustrating an algorithm implemented by the app for monitoring use of a mobile electronic device.

FIGS. 4A-4D are schematic diagrams of an example user interface on the mobile electronic device for reporting mobile electronic device use.

FIG. 5 is a schematic system diagram of back-end electronics for operation of the app for monitoring use of a mobile electronic device.

FIG. 6 is a block diagram of an example network operating environment for the mobile electronic device.

### DETAILED DESCRIPTION

The disclosure provided in the following pages describes examples of some embodiments of the invention. The designs, figures, and description are nonlimiting examples of some embodiments of the invention. Other embodiments of the system may or may not include the features disclosed herein. Moreover, disclosed advantages and benefits may apply to only some embodiments of the invention, and should not be used to limit the scope of the invention. Though the examples below are described for an app used on a mobile phone (e.g., smart phone), one of skill in the art will recognize that the app described herein can be used in other mobile electronic devices (e.g., tablet computer, wearable electronic device such as a smartwatch and/or fitness band, etc.).

In one embodiment of the invention, a novel app tracks and reduces phone interaction during paid work hours with or without accessing employee's private and personal data. While the app obtains an employee's specific location through geolocating, Wi-Fi, Li-Fi, satellite, cellular network or other position locating technology to verify the employees being within a specified area to ensure a physical presence, it also ensures employee safety. Private and personal data on the employee's mobile (or electronic) device may or may not be accessed. In another instance, the app allows employers to set multiple locations for businesses with multiple facilities or even individual locations specific to each remote or virtual employee.

One or more embodiments of the app allows employees to answer phone calls, to text, launch or interact with apps, and interact with their phone or electronic device whenever they choose. An example of the flexibility would be how it gives employees the option to interact with the mobile or electronic device or even leave the office for a given period of time for any reason, then it would automatically notify the employer if they left the facility or clocked out. Upon logging in the employee could select the reason they stopped working, took an extra break, had a personal phone call, had to respond to a text, personal emergency, etc.

The app is designed to be used during work hours. The user launches the app when they arrive at work and the app runs in the background. When a user exits the app for any reason, attempts to open another app or interact with the mobile or electronic device through any buttons or commands, the novel system automatically exits the user and logs the time the user exited as wells as the time they log back in. The app may or may not track any personal data such as contact details (e.g. name, phone number, email address, or other details), or activity type (e.g. sending or responding to a text message, email, phone call, etc.). It measures data including times entering and exiting the app and entering or exiting the geo-location, Wi-Fi or specified area. This user elected offering of phone interaction allows comparison of data and productivity over a span of time.

In some embodiments, the app logs out every time users touch volume buttons, swipe the screen, use motion activated commands, verbal commands or any other form of interaction with the phone or device.

The app can also provide an added level of safety by providing employers with the names and number of employees that are inside the specified area (e.g., work location, work facility) in case of a fire, earthquake or other disaster.

In another embodiment, the system reports the activity data to a server, or data repository, where the user, other users, or an employer can access the activity data.

During login, one embodiment of the app uses administration configurable internet or data connection verification such as Wi-Fi (Li-Fi or other method of connecting to an employer provided internet connection). The admin has the option to control if the app requires Wi-Fi (or above stated) verification from an admin panel. If the Wi-Fi (or above stated) verification is enabled, the app allows employees to login if they have connected to an employer's Wi-Fi (or above stated) network. This ensures that employees are within the employer's facility. While some employers might be concerned with employees tying up Wi-Fi (or above stated) bandwidth, with the app, employees will likely reduce their phone usage during work hours except for breaks and lunch.

The employer or (an administrator) can set login and logout times for the app as well as automatic logout times with a reminder that it is time for the employee to leave work. Alternatively, the app can be configured to not logout at a specific time. In other embodiments, the app can use notification pop ups reminding employees to clock out, along with one or more customizable options (assigned by the administrator) such as “clock out, I'm working on a time sensitive project, etc.” The logout time can be set based on the time an employee clocks in (ex. clocked in 8:15, clock out reminder should be 4:15), or allow the administrator to set a clock out reminder time of 5, 10, 15 minutes before actual clock out time to avoid going into overtime.

The app can also remind employees to login during work hours if they have not logged by the pre-defined time through an alarm or other notification (e.g., popup notification). Upon login, the app records login time and updates the server so the employer knows when the employee began working.

In yet another embodiment, the App allows an employee to login if the employee is in a specified geo-fence (or specific area specified by the employer) or if the employer chooses they can be logged into the company provided Wi-Fi (or other internet or data connection) to ensure they are within the premises.

Typically, the employee stays logged into the app until the employee clicks out, takes a call, responds to a push notification, interacts with their device, or leaves the geo fence (or employer specified area) or the Wi-Fi network (or employee provided internet or data connection). If the employee has logged out of the app, a push notification will pop up during employee work hours. The pop up can occur after different time periods, such as after 5 minutes.

Once the employee logs back into the app a welcome screen appears with a drop down of reasons why the employee logged out and updates the server with the reason. The administrator can also configure options for the list of reasons.

In addition, if the employee leaves the geo-fence (or employer specified area), or drops the Wi-Fi connection (or employee provided internet or data connection), during working hours the employee will automatically be logged out of the app and the app will report “exited premises.”

The app also optionally works with a fingerprint login feature to verify the employee's identity as well as for security reasons.

In addition, the employer can configure the app to set the employee number, full name, or an identifier that the administrator system can cross reference. The app can also interface with different payroll company application programming interfaces that include by way of example, application programming interfaces for ADP, Paychex and Intuit.

“Super user” (employer, manager or HR): Super can create account for companies who want to track their employees. An ability also exists for the client to add their company logo through the administration panel to show up in the employee dashboard. Another option can include a custom design or a custom splash screen and/or custom user interface.

The app is typically active for the duration of the time the employee is in the office. Companies can set geo tags or set area locations that define whether an employee leaves a location. Furthermore, in such situations the app can send alerts will go to the administrator or manager. Still further, administrators can create employee specific geo fencing and also schedule employees for particular locations.

An administrator can also create mobile patrol locations where employees, administrators, or managers can see employees on a map and track employee geo locations in the field.

A push notification can also be configured to pop up on the employees' phones via the app that notifies them that they are going into overtime. The administrators can also set customizable fields notifying the employee to either “clock out, please contact supervisor for overtime approval, etc.”

In still other embodiments, administrators can track employee working hours throughout the week. For example, after 40 hours work, the employee tracking can show in red color so that administrators will know which employee is working overtime or which are not and whether the employees have rights to work overtime.

Still further, daily allowances or traveling allowances can be accessible in an associated website panel. Optional features include the ability for the employee to set when they leave, when they arrive, track total travel time, miles, etc. Administrative configurable options can also set travel time, pay rate, mileage reimbursement rate, etc.

Advanced reporting—the app dashboard will have the appearance & functionality to analyze employee behavior. The user interface includes, but is not limited to, bar graphs and pie charts.

Reporting will include standard and custom reports that can be exported to excel and pdf formats. The report can, for example, indicate how much time employees have on visited sites (top 10, 20, 30, etc.). The report can further include places visited for more than 10 minutes - report of locations visited, arrival time, departure time, total time spent there (during work hours when clocked in).

The system can generate reports in the background, and send emails when a report is ready or create a report library that is time stamped.

In yet other embodiments, the app allows the ability to log HR complaints, the ability to request personal time off (PTO), and options to track mileage driven for reimbursement.

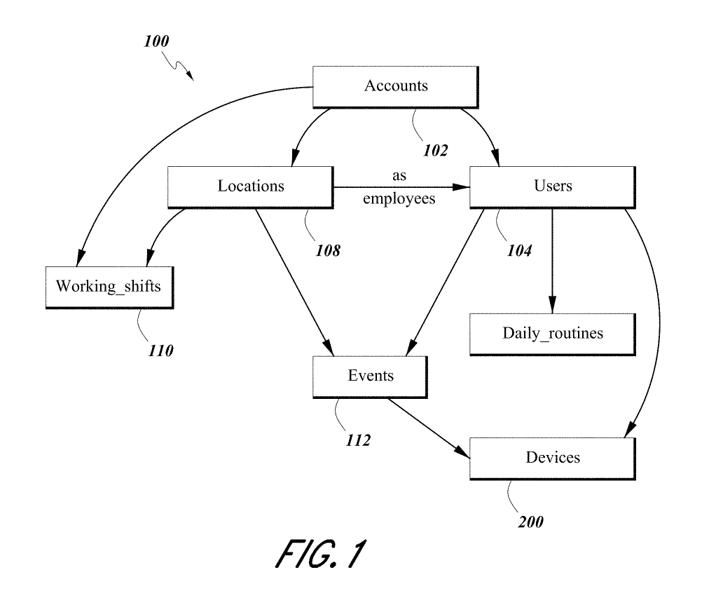

FIG. 1 shows a logical diagram illustrating interactions between different components of one embodiment of a mobile application software (an “app”) 100 for monitoring use of a mobile electronic device (e.g., a smartphone) 200. The app 100 can allow an account (e.g., a customer, and employer, enterprise account) 102 to be associated with one or more users 104 (e.g., one or more employees), each of which are associated with devices 200 (e.g., with mobile phones, smartphones). One or more geographical locations (e.g., work facilities) 108 can be associated with an account 102. For example, if the customer/employer has more than one business location (e.g., in multiple cities, states, etc.), the app 100 can associate such multiple locations 108 with the account 102.

The users 104 for each account 102 can be associated with a particular location 108 for the account 102, thereby grouping users 104 by their location 108. Additionally, one or more working shifts (e.g., a plurality of different working shifts) 110 can be associated with the one or more locations 108 for a given account 102. The working shift 110 can be the assigned work periods during which the users 104 are due to be at work (e.g., morning shift from 8 am to 4 pm, night shift 12 am to 8 am, swing shift 4 pm to 12 am, etc.). The app 100 can associate events 112 for each user 104 and location 108. Such events 112 can optionally include, but are not limited to, for example, a clock-in event when the user 104 starts their workday, a clock-out event when the user 104 ends their workday, a break-in event when the user 104 begins a break period, and a break-out event when the user 104 ends a break period. The app 100 executes daily routines 114 (via the server) independent from any action from the user. Such daily routines 114 can include, for example, updating or cleaning data records, without user input, e.g., using data generated by the users/employees 104 while using the app 100. Further discussion of the architecture of the app 100 is provided below.

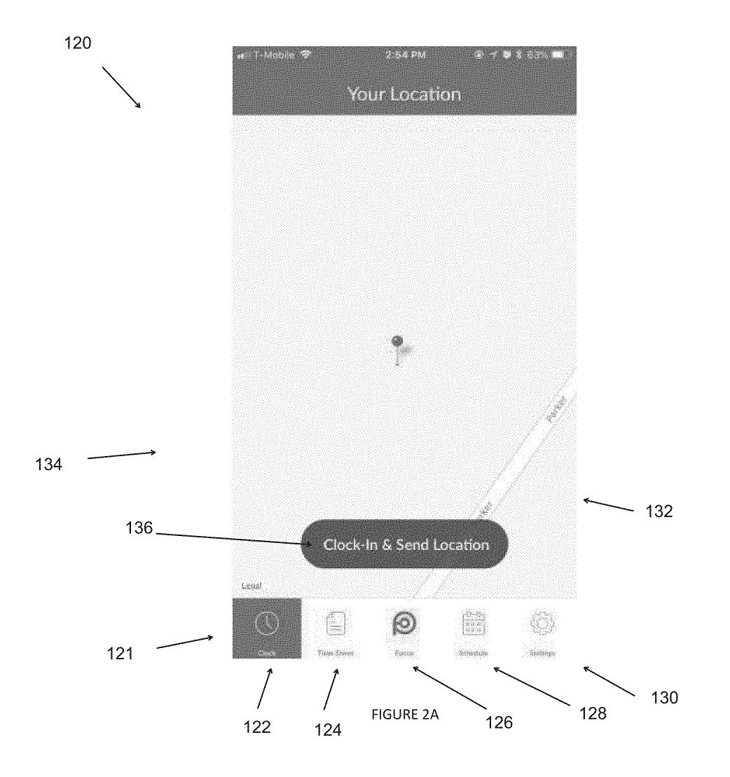

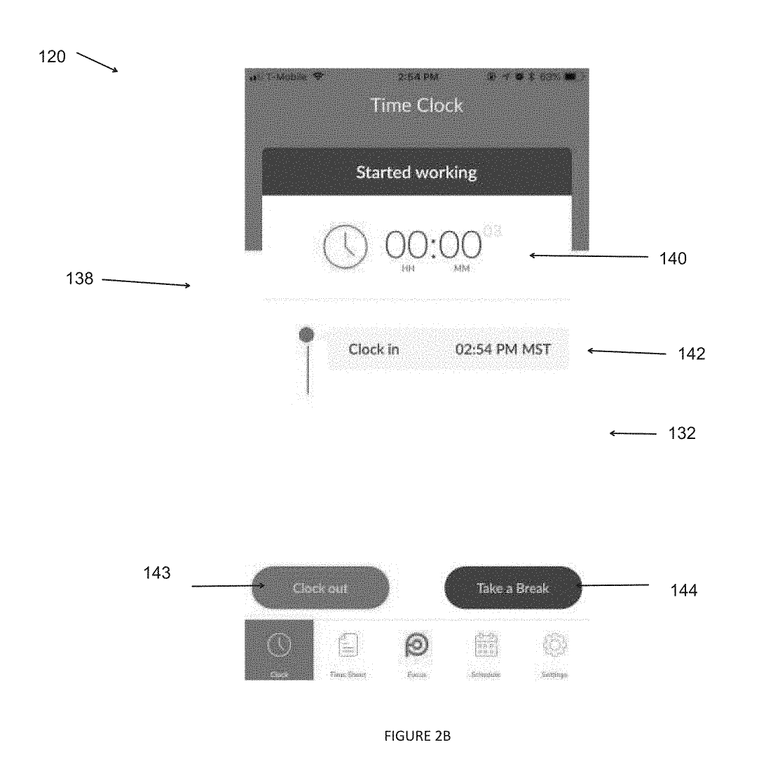

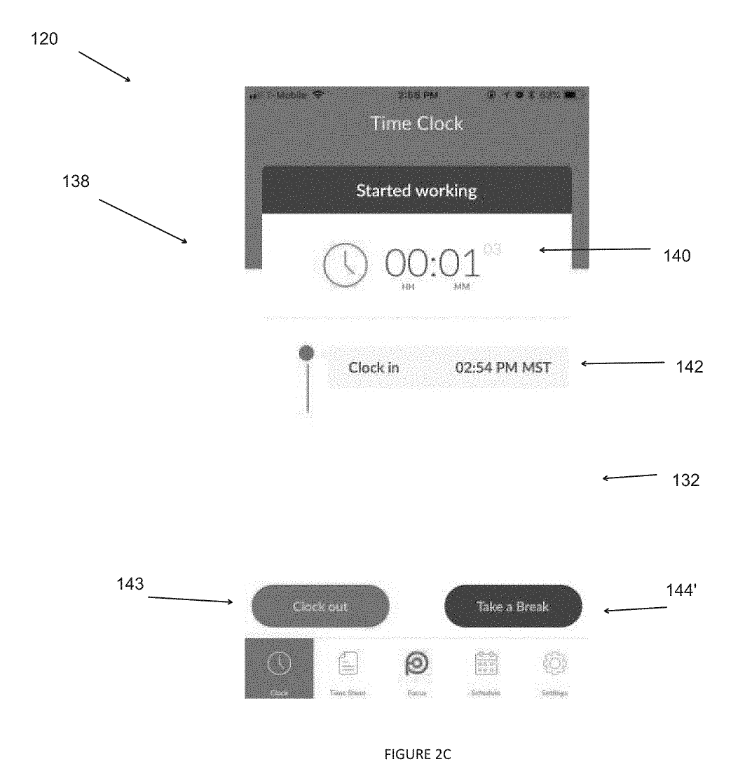

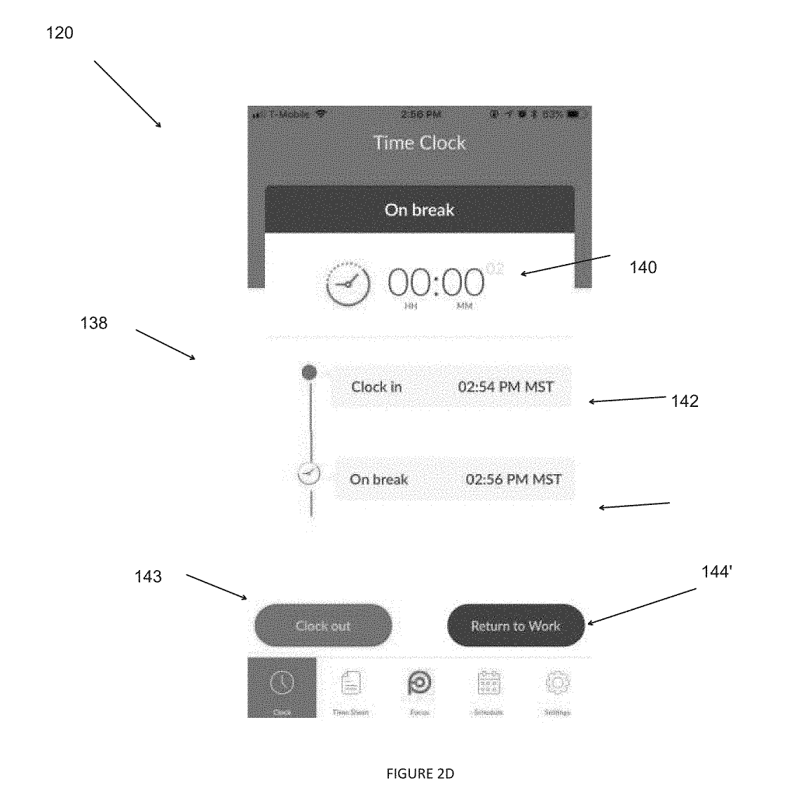

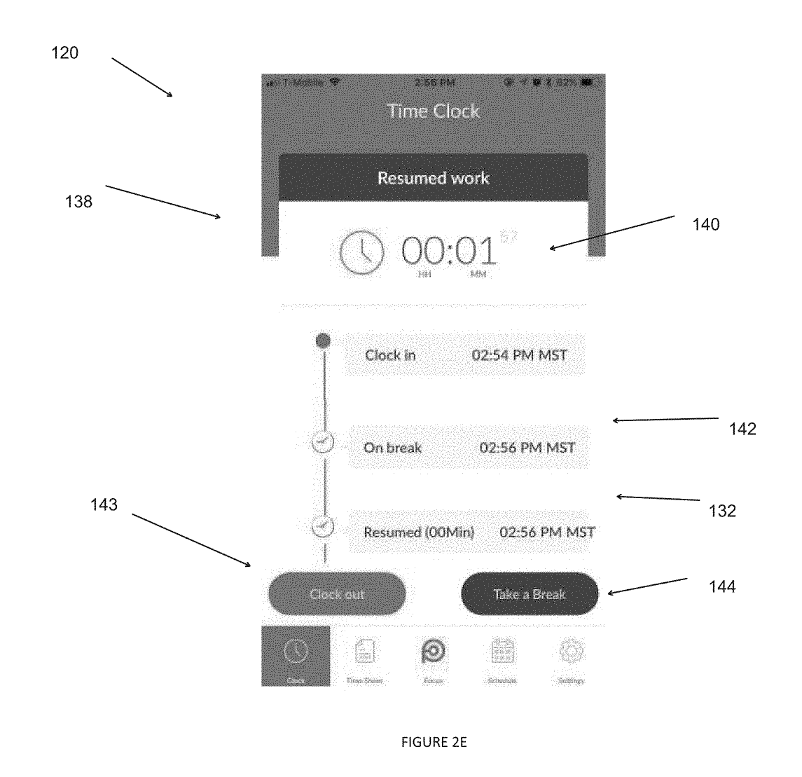

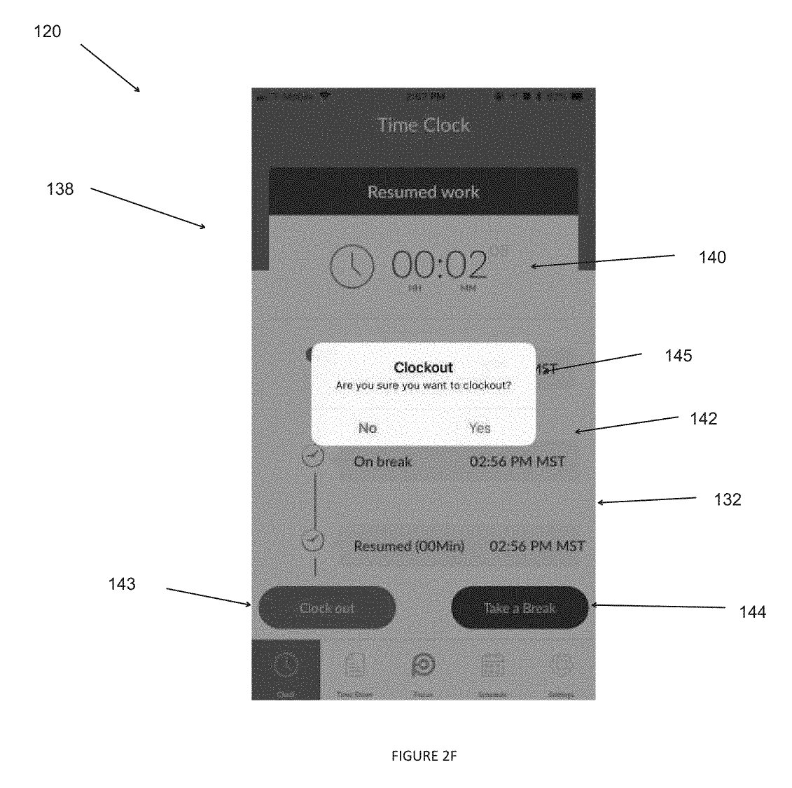

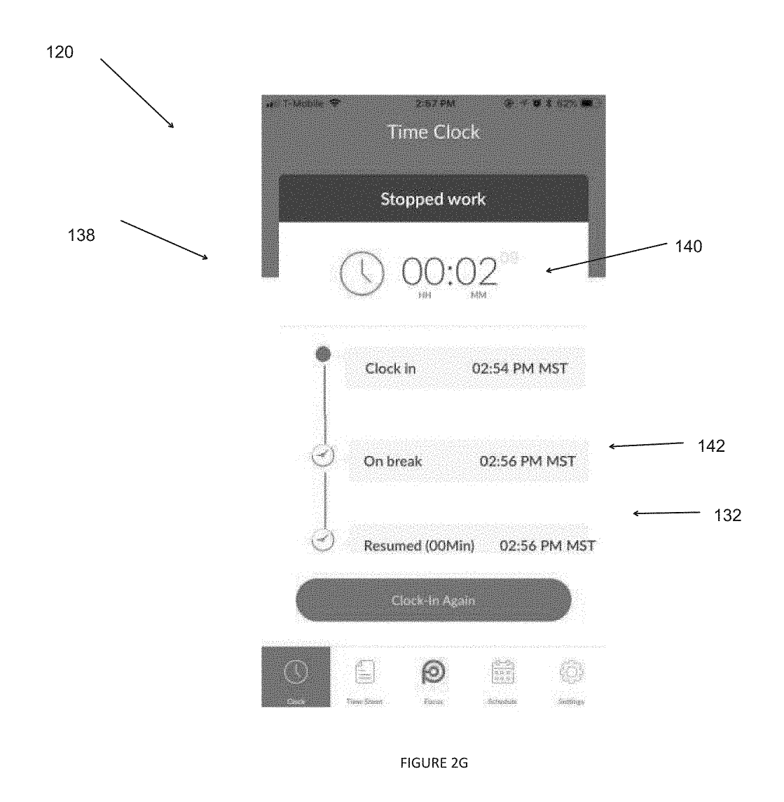

FIGS. 2A-2G show different screen shots of a graphical user interface GUI 120 of the app 100 in use. The GUI 120 can optionally include a menu bar 121, in which one or more objects are displayed. In the illustrated embodiment, the menu bar 121 displays a clock object 122, a time sheet object 124, a focus object 126, a schedule object 128 and a settings object 130. Touching one of the objects 122, 124, 126, 128, 130 can, for example, invoke corresponding functionality, as further described below. The GUI 120 can also include a display object 132 that displays graphical representations of system objects, as further described below.

A user 104 associated with an account 102 can login to the app 100, for example when they arrive at their work location 108 for their work shift 110, by opening the app 100 on their device 200 (e.g., mobile phone). FIG. 2A shows a sample login screen 134 provided by the GUI 120 once the app 100 has been opened by the user 104. To log onto the app 100, the user 104 can optionally click on the “clock-in” object 136. In another implementation, the user can enter their mobile phone number into the app 100 via the login screen 134, and the app 100 can send the user 104 a pass-code (e.g., via an SMS message) from a server associated with the app 100, which the user can enter via the GUI 120 to complete the login process. Optionally, the passcode can be different every time the user 104 logs onto the app 100. In another implementation, generation/communication of the passcode is excluded, and the user 104 completes the login process by solely entering their mobile phone number.

With continued reference to FIG. 2A, the user's 104 location 108 is also communicated during the login process. Optionally, the app 100 accesses the location 108 information using the geolocation technology used by the mobile phone 200, as described above. In another implementation, where the app 100 does not access geolocation information for the mobile phone 200 of the user 104, the app 100 can communicate to the user 104 via the display object 132 of the GUI 120 the various locations 108 (e.g., facilities) associated with the user 104 for the account 102 (e.g., employer) and ask the user 104 to select their current location 108.

Once the login has been completed, for example by selecting the “clock-in” object 136, the GUI 120 of the app 100 displays a time clock screen 138 in the display object 132. Optionally, the time clock screen 138 can have a timer 140, a time history table 142, a “clock out” object 143 and a “take a break” object 144.

The timer 140 begins to run (see FIG. 2C) until one or more events 112 occur. For example, as shown in FIG. 2D, the user 104 can select the “take a break” object 144 to begin a break period (e.g., break event), at which point the timer 140 for the work period is stopped. Optionally, the timer 140 for the break period is displayed on the display object 132 of the GUI 120 to track the length of the break period. During the break period, the “take a break” object 144 converts to a “return to work” object 144′. The time history table 142 can optionally display the different events 112 that occur for the user 104 during the work shift 110 (e.g., clock in time, break start time, break end time, clock out time).

As shown in FIG. 2E, once the break period or event is over, the user 104 selects the “return to work” object 144′ and the timer 140 resumes tracking the length of the work period. The “return to work” object 144′ converts back to a “take a break” object 144. The user 104 can take multiple break periods during the work shift 110, and the timer 140 will track the overall work period (i.e., by not counting the break periods during the work shift 110 because the work period timer 140 stops during a break; or, for example, by subtracting the time transpired for the one or more break periods from the overall time transpired for the work shift 110).

FIG. 2F shows the GUI 120 once the user 104 selects the “clock out” object 143. Optionally, the GUI 120 displays a pop-up notification 145 to the user 104 asking them to confirm that they do want to clock out. Once confirmed by the user 104, the timer 140 on the time clock screen 138 stops and illustrates the transpired work period, as shown in FIG. 2G.

As discussed above, the app 100 not only records when the user 104 is on a break, but also when the user 104 is otherwise using their mobile electronic device (e.g., mobile phone, smartphone) 200 during the work shift 110 in order to track work efficiency and/or interactions with the mobile electronic device 200. As used herein, an “Interaction” is defined as an event, while the user 104 is clocked-in to the app 100, where the app 100 state changes to “background” due to the user 104 accessing some other app on the mobile electronic device 200 (e.g., text app, social media app, web browser, etc.) or otherwise interacting with the phone 200 (e.g., making a call, touching buttons on the phone, etc.). An interaction counter keeps track of each such interaction event throughout the work shift 110. As used herein, “efficiency” percentage is defined as the total work period registered by the counter 140 divided by the total transpired period of time (e.g. at the time the efficiency is calculated). The “efficiency” is optionally continually calculated and communicated to the back-end 400 of the app 100, as discussed further below. In one example, the efficiency percentage can be calculated at the end of the work shift 110.

In general with mobile phones, in order to preserve battery level, after a period of time the screen of the mobile electronic device 200 goes black (e.g., dims) and apps, such as the app 100, go to the background. However, the app 100 can also move to the background if the user 104 opens another app (e.g., text app, social media app, web browser) so that the user 104 is interacting with the mobile electronic device 200 (e.g., smartphone). A problem advantageously solved by the app 100 involves the inability of mobile phone operating systems (e.g., iOS, Android) to identify whether the app 100 has moved to the background because the screen of the mobile phone 200 dims (e.g., user 104 still focused/engaged in work), of if the app 100 has moved to the background because the user 104 is now using another app or function on the mobile phone 200 or otherwise interacting with the mobile phone 200 (e.g., user 104 is not focused on work).

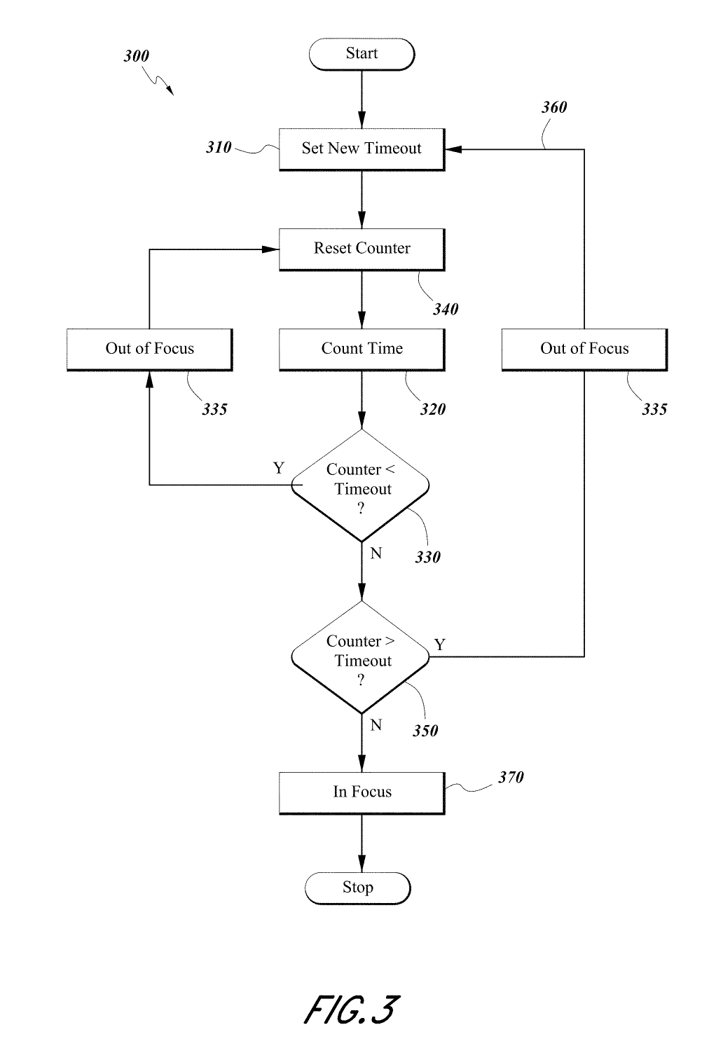

FIG. 3 shows a schematic diagram of an algorithm 300 used by the app 100 for advantageously determining whether a transition of the app 100 to the background is due to interaction between the user 104 and mobile electronic device 200 (e.g., user 104 not focused on work) or if it is due to the screen of the mobile electronic device 200 (e.g., mobile phone) going black (e.g., dimming) to conserve battery life (e.g., the user 104 is still focused on work). Such determinations advantageously allow the app 100 to take such user interactions with their phones (e.g., when user 104 not focused on work because they are using their phone 200) in calculating the efficiency of the user during the work shift 110.

At the start, the algorithm 300 sets 310 a predetermined timeout period TOP (e.g., 30 seconds) for the mobile electronic device 200. The predetermined timeout period is the value initially assumed to correspond with the timeout period used by the mobile electronic device (e.g., mobile phone) 200. By timeout period, we mean the period of time that transpires between a user interaction with the phone 200 (e.g., tapping on phone, etc.) and when the screen of the phone 200 goes dark (e.g., to conserve battery power). The app 100 tracks the interaction with the phone 200 (e.g., touch, tap, etc.) and begins a counter from said interaction. The counter is reset every time the user interacts with the phone 200. Once the state of the app 100 changes to background, the app 100 records 320 the time at which the state of the app 100 changed to background and a time duration elapsed (Δsto) between the last user interaction with the phone 200 (e.g., touch, tap, etc.), based on the counter time, and said timestamp for the app state changing. The elapsed time duration (Δsto) is then compared to the stored timeout period. If the values are the same, then the user 104 is deemed to be focused on work (e.g. to be in focus and not distracted). If the Δsto is less than the 330 the time out period, the Δsto is deemed to be due to an interaction 335 between the user 104 and the mobile phone 200 (e.g., the user 104 is not focused on work). The counter is reset 340 to zero, and the app 100 waits to record the next time the app 100 changes to a background state after being in a foreground state. The app 100 continues to record 320 these elapsed time durations Δsto when the app 100 state transitions from foreground to background. When a predetermined number (e.g., 3, 4, etc.) of such durations Δsto are received with an identical value (e.g., consecutively received with the identical Δsto value), then said value of the duration Δsto is assumed to be the new screen time out period and the time out period is reset to this value. This is because the likelihood that a user 104 is interacting with their phone in a manner that achieves an exact duration Δsto is very low, meaning that such repeated values for the duration Δsto is more likely due to being the screen timeout period programmed into the mobile phone 200 (e.g., to conserve battery power).

With continued reference to FIG. 3, on every state change (e.g., of the app 100 to background), if the elapsed time duration Δsto is greater than 350 the current evaluated screen timeout period TOP, then the algorithm 300 assumes that the current screen timeout period TOP is incorrect or the user 104 has changed the screen time out for the mobile electronic device 200. In such a case the algorithm 300 sets 360 a new assumed timeout period TOP′ to be the elapsed time duration Δsto + and additional amount X (e.g., additional 5 seconds, 10 seconds, 15 seconds) and clears the array which was retaining different Δsto values for calculations.

If the Δsto is neither less than nor greater than the current evaluated screen timeout period TOP, the user is deemed to still be focused 370 on work (i.e., the app 100 changing to background state is not due to user 104 interaction with the phone 200, but instead due to the normal timeout period for the phone 200 screen dimming or going dark). In this manner, the app 100 classifies each Δsto value as one involving either a user interaction with the mobile phone 200 (e.g., user 104 not focused on work) or as one due to the normal timeout period of the mobile phone 200 (e.g., user 104 still focused 370 on work) and uses such determinations in calculating the efficiency value for the user 104. For example, the efficiency of the user 104 would optionally be calculated by subtracting from a given time period any break periods the user has taken in that time period as well as any Δsto periods that occurred during that time period that were classified as ones involving a user interaction with the mobile phone 200 (e.g., user 104 not focused on work), and dividing this value by the given time period.

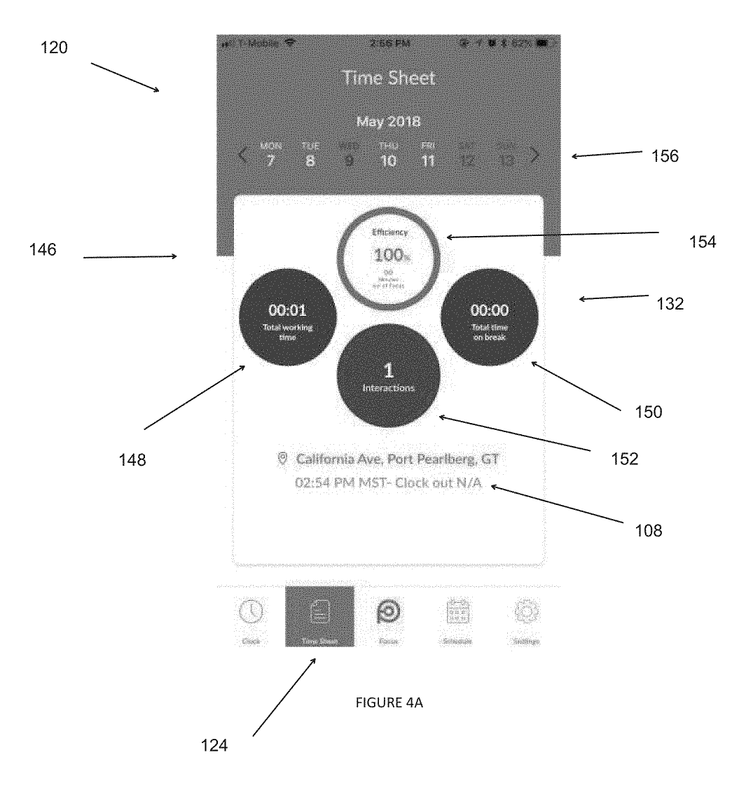

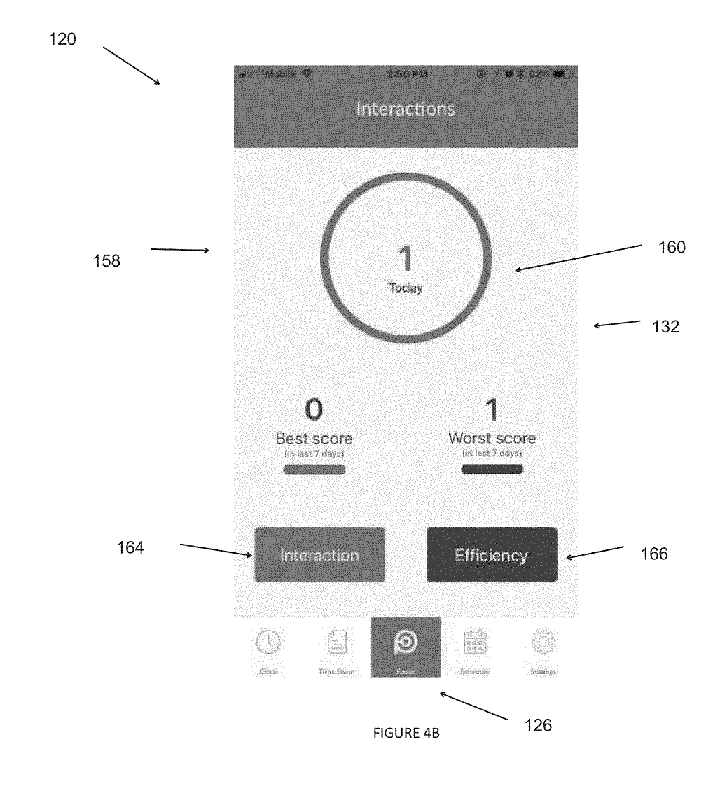

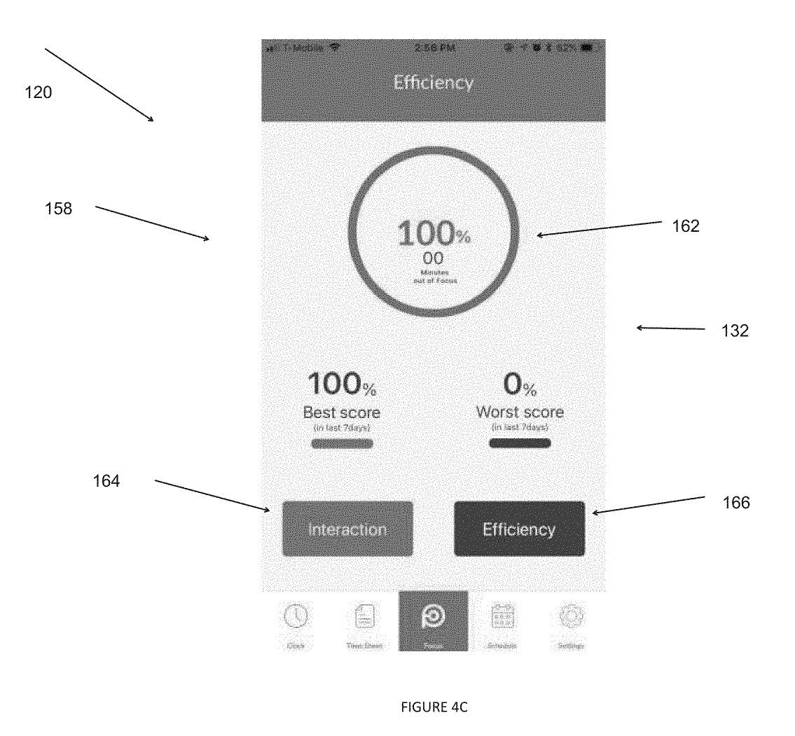

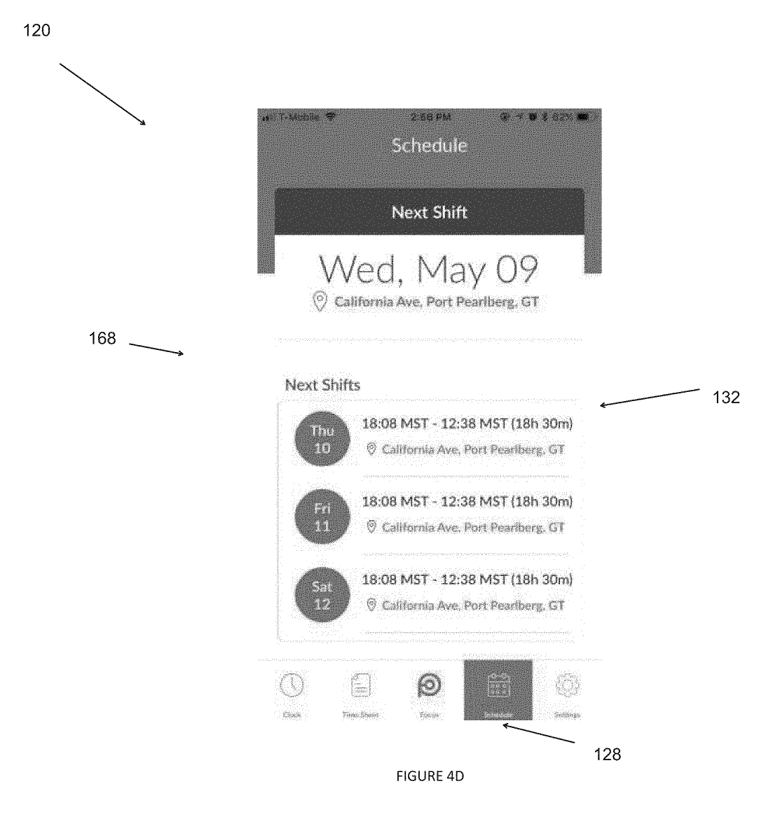

FIGS. 4A-4D show schematic diagrams reports provided on the display object 132 of the GUI 120. FIG. 4A shows a time sheet screen 146, accessible by selecting the “time sheet” object 124. The time sheet screen 146 optionally provides a dashboard showing the total work recorded working time 148, total break recorded time 150, number of interactions with the phone 152 and efficiency 154 of the user 104. Such data can be stored per calendar day, allowing the user 104 to access such information from the time sheet screen 146 for different calendar days (e.g., of the work week) by selecting them from the calendar time line 156. Optionally, the time sheet screen 146 can show the work location 108 and the clock-out time for the user 104. The dashboard can be generated at any time based on data compiled for the time transpired thus far in the work shift 110 (e.g., if the time sheet 124 object is selected at the middle of the work shift 110, it will show the dashboard data, such as number of interactions and efficiency, though that time, if the time sheet 124 object is selected at the end of the work shift 110, it will show the dashboard data, such as number of interactions and efficiency, for the entire work shift 110, etc.).

FIG. 4B shows a focus screen 158, accessible by selecting the “focus” object 126. The focus screen 158 optionally provides information on interactions 160 and efficiency 162 for the user 104. FIG. 4B shows the number of interactions by the user 104 with the mobile electronic device 200 (e.g., smartphone) during the calendar day (e.g., following selection of the “interaction” object 164 on the focus screen 158 by the user 104. Optionally, the app 100 can provide data on the interaction score over a period of time (e.g., 1 week, 1 month), allowing the user 104 to compare their interaction score for the present day relative to their worst and their best score over said period of time. The interaction score can be generated at any time based on data compiled for the time transpired thus far in the work shift 110 (e.g., if the focus object 126 and interaction object 164 are selected at the middle of the work shift 110, it will show the number of interactions, through then; if the focus object 126 and interaction object 164 are selected at the end of the work shift 110, it will show the number of interactions for the entire work shift 110, etc.).

FIG. 4C shows the focus screen 158 once the “efficiency” object 166 has been selected, which displays the calculated efficiency percentage of the user 104. Optionally, the app 100 can provide data on the efficiency score over a period of time (e.g., 1 week, 1 month), allowing the user 104 to compare their efficiency score for the present day relative to their worst and their best score over said period of time. The efficiency score can be generated at any time based on data compiled for the time transpired thus far in the work shift 110 (e.g., if the focus object 126 and efficiency object 166 are selected at the middle of the work shift 110, it will show the efficiency score, through then; if the focus object 126 and efficiency object 166 are selected at the end of the work shift 110, it will show the efficiency score for the entire work shift 110, etc.).

FIG. 4D shows the schedule screen 168, accessible by selecting the “schedule” object 128. The schedule screen 168 can list upcoming shift periods for the user 104, and can include one or more of the date of the workday, the start time and end time for the work shift 110, and the location for the work shift 110.

Optionally, the app 100 allows the account 102 (e.g., employer) to access similar reports as shown in FIGS. 4A-4D (e.g., via their mobile phone, tablet computer, laptop computer) for one or more users (e.g., employees) 104. In one example, the app 100 can generate reports for multiple users 104 for the employer to compare their relative interaction and efficiency scores. Such reports can be provided in any number of suitable formats (e.g., bar charts, pie charts, tables) and be convertible to a variety of file formats (e.g., spreadsheet, MS Word document, text file, etc.).

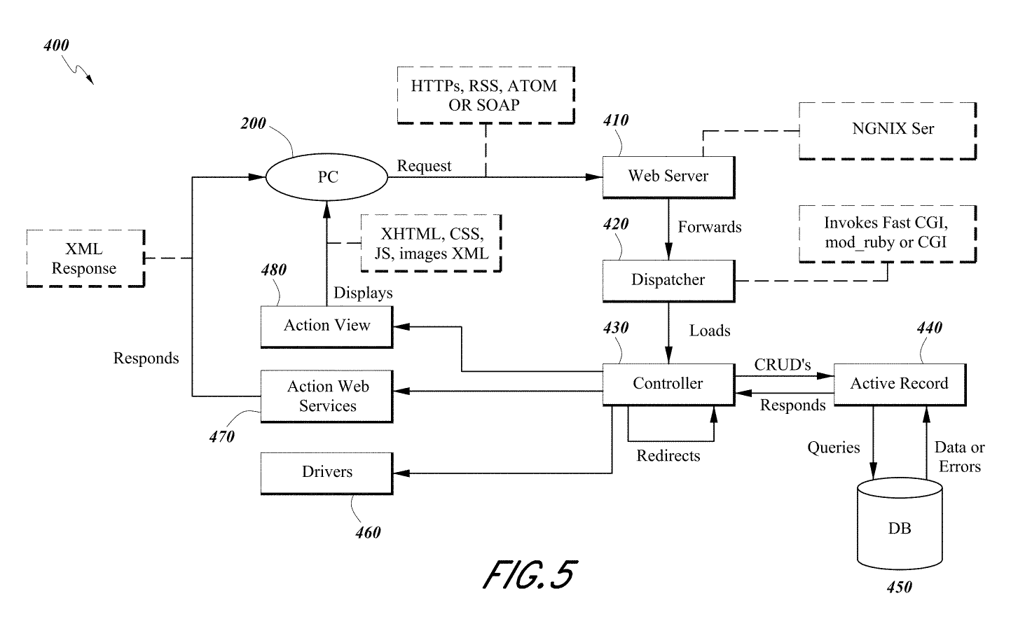

FIG. 5 shows a technical diagram of the back-end electronics 400 for operation of the app 100 for monitoring use of a mobile electronic device (e.g., mobile phone, smartphone, etc.), and can optionally have one or more of the components shown in FIG. 5 and described below. The mobile electronic device 200 running the app 100 can send a request (e.g., using one or more communication protocols, such as HTTPS, RSS, ATOM, SOAP, etc.) to a web server 410 (e.g., NGINX server). The server 410 forwards the request to a dispatcher 420 (e.g., which can invoke a protocol such as FastCGI, mod_ruby, or CGI). The dispatcher 420 loads the request to the controller 430, which in turn sends a create, read, update, or delete (CRUD) request to an active record 440. The active record 440 communicates with a database 450 (e.g., sending queries to the database 450, receiving data or errors from the database 450). The active record 440 communicates the response from the database 450 to the controller 430. The controller 430 communicates the response to one or more of drivers module 460, action web services module 470, and action view module 480. The action web services module 470 can communicate the response from the controller 430 to the mobile electronic device (e.g., mobile phone) 200 (e.g., as an XML response). The action view module 480 can communicate the response from the controller 430 to the mobile electronic device (e.g., mobile phone) 200 (e.g., in the form of XHTML, CSS, JS, images and XML).

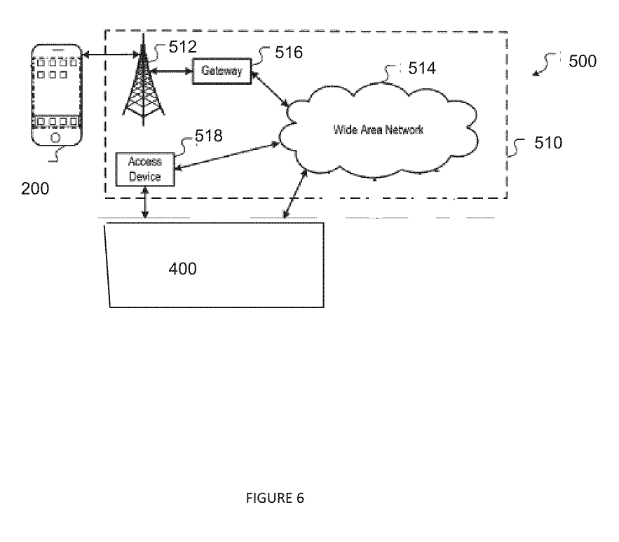

FIG. 6 is a block diagram of an example network operating environment 500 for the mobile electronic device (e.g., mobile phone, smartphone) 200, via which it can communicate with the back-end electronics of the app 100. The mobile device 200 can, for example, communicate over one or more wired and/or wireless networks 510 in data communication. For example, a wireless network 512, e.g., a cellular network, can communicate with a wide area network (WAN) 514, such as the internet, by use of a gateway 516. Likewise, an access device 518, such as an 802.11g wireless access device 518, can optionally provide communication access to the WAN 514. The mobile device 20 can communicate with one or more services, such as the app back-end electronics 400 via the one or more wired and/or wireless networks 510. The mobile device can also access data and content over the one or more wired and/or wireless networks 510.

The various illustrative logical blocks, modules, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, microcontroller, state machine, combinations of the same, or the like. A processor may also be implemented as a combination of computing devices, e.g., a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, hard disk, a removable disk, a CD-ROM, memory capable of storing firmware, or any other form of computer-readable storage medium known in the art. An exemplary computer-readable storage medium can be coupled to a processor such that the processor can read information from, and write information to, the computer-readable storage medium. In the alternative, the computer-readable storage medium may be integral to the processor. The processor and the computer-readable storage medium may reside in an ASIC, DNA digital data storage (technology using artificial DNA made using commercially available oligonucleotide synthesis machines for storage and DNA sequencing machines for retrieval)

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multithreaded processing, interrupt processing, or via multiple processors or processor cores, rather than sequentially.

Conditional language used herein, such as, among others, “can,” “could,” “might,” “may,” “e.g.,” and from the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain embodiments of the inventions described herein may be embodied within a form that does not provide all of the features and benefits set forth herein, as some features may be used or practiced separately from others.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. For example, one portion of one of the embodiments described herein can be substituted for another portion in another embodiment described herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A computer implemented method for monitoring and reporting mobile phone use while at work, comprising:
receiving a first touch input to a first display object in a graphical user interface of an app displayed on a mobile electronic device indicative of a clock-in time of a work period;
initiating a work time counter in response to said first touch input to track a period of time;
recording one or more break periods upon receiving on a second display object in the graphical user interface on the mobile electronic device a second touch input indicative of a break start time and a third time input indicative of a break end time, said second touch input initiating a break time counter and said third touch input stopping said break time counter;
stopping the work time counter in response to said second touch input and resuming the work time counter in response to said third touch input;
identifying one or more user interaction events during which the user interacts with the mobile electronic device so that the app changes to a background state and recording a user interaction time period for each of the one or more user interaction events;
receiving a fourth touch input to the first display object in the graphical user interface indicative of a clock-out time for the work period; and
calculating an efficiency score for the user over a transpired time period by subtracting from the transpired time period the one or more break periods measured from the break start time to the break end time, and subtracting from the transpired time period the one or more user interaction time periods.

2. The method of claim 1, wherein identifying the one or more user interaction events includes counting with a counter a total number of separate user interaction events with the mobile electronic device over the transpired period of time to generate an interaction score over the transpired period of time.

3. The method of claim 2, further comprising generating a report of one or both of the efficiency score and the interaction score and displaying it via the graphical user interface.

4. The method of claim 1, wherein identifying the one or more user interaction time periods comprises
setting a screen timeout period for the graphical user interface of the mobile electronic device;
monitoring interactions between the user and the mobile electronic device and restarting a counter every time the user interacts with the mobile electronic device;
identifying with a timestamp when the app transitions to the background state;
recording an elapsed time period from a timestamp for the last user interaction with the mobile electronic device and the timestamp for the transition to the background state;
recording as a user interaction period the recorded elapsed time period if the elapsed time period is less than the screen timeout period;
increasing the screen timeout period by a first amount if said elapsed time period is greater than a previously recorded screen timeout period; and
resetting the screen timeout period to the elapsed time if said elapsed time period is recorded for a plurality of consecutive monitored interactions.

5. The method of claim 4, wherein monitoring interactions includes monitoring one or more of touches of one or more buttons or objects of the mobile electronic device, one or more swipes of a screen of the mobile electronic device, monitoring receipt of one or more motion activated commands, and receipt of one or more verbal commands.

6. The method of claim 1, further comprising receiving a user login identification prior to initiating the work time counter in response to said first touch input.

7. The method of claim 6, wherein receiving the user login identification comprises receiving one or more of a user mobile phone number and a passcode

8. The method of claim 1, further comprising receiving a user location identification prior to initiating the work time counter in response to said first touch input.

9. A system for monitoring and reporting mobile phone use while at work, comprising:
one or more computing devices including one or more processors, one or more memory devices, and one or more network interface devices;
a web server application stored in the one or more memory devices and executable by the one or more processors to receive, process, and respond to data requests received via the one or more network interface devices from an app on a mobile electronic device,
the one or more processors being operable to perform operations comprising:
receiving a first touch input to a first display object in a graphical user interface of an app displayed on a mobile electronic device indicative of a clock-in time of a work period;
initiating a work time counter in response to said first touch input to track a period of time;
recording one or more break periods upon receiving on a second display object in the graphical user interface on the mobile electronic device a second touch input indicative of a break start time and a third time input indicative of a break end time, said second touch input initiating a break time counter and said third touch input stopping said break time counter;
stopping the work time counter in response to said second touch input and resuming the work time counter in response to said third touch input;
identifying one or more user interaction events during which the user interacts with the mobile electronic device so that the app changes to a background state and recording a user interaction time period for each of the one or more user interaction events;
receiving a fourth touch input to the first display object in the graphical user interface indicative of a clock-out time for the work period; and
calculating an efficiency score for the user over a transpired time period by subtracting from the transpired time period the one or more break periods measured from the break start time to the break end time, and subtracting from the transpired time period the one or more user interaction time periods.

10. The system of claim 9, wherein identifying the one or more user interaction events includes counting with a counter a total number of separate user interaction events with the mobile electronic device over the transpired period of time to generate an interaction score over the transpired period of time.

11. The system of claim 10, wherein the mobile device is operable to generate a report of one or both of the efficiency score and the interaction score and displaying it via the graphical user interface.

12. The system of claim 9, wherein identifying the one or more user interaction time periods comprises
setting a screen timeout period for the graphical user interface of the mobile electronic device;
monitoring interactions between the user and the mobile electronic device and restarting a counter every time the user interacts with the mobile electronic device;
identifying with a timestamp when the app transitions to the background state;
recording an elapsed time period from a timestamp for the last user interaction with the mobile electronic device and the timestamp for the transition to the background state;
recording as a user interaction period the recorded elapsed time period if the elapsed time period is less than the screen timeout period;
increasing the screen timeout period by a first amount if said elapsed time period is greater than a previously recorded screen timeout period; and
resetting the screen timeout period to the elapsed time if said elapsed time period is recorded for a plurality of consecutive monitored interactions.

13. The system of claim 12, wherein monitoring interactions includes monitoring one or more of touches of one or more buttons or objects of the mobile electronic device, one or more swipes of a screen of the mobile electronic device, monitoring receipt of one or more motion activated commands, and receipt of one or more verbal commands.

14. The system of claim 9, further comprising receiving a user login identification prior to initiating the work time counter in response to said first touch input.

15. The system of claim 14, wherein receiving the user login identification comprises receiving one or more of a user mobile phone number and a passcode.

16. The system of claim 9, further comprising receiving a user location identification prior to initiating the work time counter in response to said first touch input .

17. A computer program product for monitoring and reporting mobile phone use while at work, the computer program product stored on a computer readable medium comprising instructions that when executed on a server cause the server to perform operations comprising:
receiving a first touch input to a first display object in a graphical user interface indicative of a clock-in time of a work period, the first display object being associated with an app interface on a mobile electronic device;
initiating a work time counter in response to said first touch input to track a period of time;
recording one or more break periods upon receiving on a second display object in the graphical user interface a second touch input indicative of a break start time and a third time input indicative of a break end time, the second display object being associated with the app interface on the mobile electronic device, said second touch input initiating a break time counter and said third touch input stopping said break time counter;
stopping the work time counter in response to said second touch input and resuming the work time counter in response to said third touch input;
identifying one or more user interaction events indicative of user interaction with the mobile electronic device when the app interface on the mobile electronic device transitions to a background state;
recording a user interaction time period for each of the one or more user interaction events;
receiving a fourth touch input to the first display object in the graphical user interface indicative of a clock-out time for the work period; and
calculating an efficiency score for the user over a transpired time period by subtracting from the transpired time period the one or more break periods measured from the break start time to the break end time, and subtracting from the transpired time period the one or more user interaction time periods.

18. The computer program product of claim 17, wherein identifying the one or more user interaction events includes counting with a counter a total number of separate user interaction events with the mobile electronic device over the transpired period of time to generate an interaction score over the transpired period of time.

19. The computer program product of claim 17, further comprising generating a report of one or both of the efficiency score and the interaction score and displaying it via the graphical user interface on the mobile electronic device.

20. The computer program product of claim 17, wherein identifying the one or more user interaction time periods comprises
setting a screen timeout period for the graphical user interface of the mobile electronic device;
monitoring interactions between the user and the mobile electronic device and restarting a counter every time the user interacts with the mobile electronic device;
identifying with a timestamp when the app interface transitions to the background state;
recording an elapsed time period from a timestamp for the last user interaction with the mobile electronic device and the timestamp for the transition to the background state;
recording as a user interaction period the recorded elapsed time period if the elapsed time period is less than the screen timeout period;
increasing the screen timeout period by a first amount if said elapsed time period is greater than a previously recorded screen timeout period; and
resetting the screen timeout period to the elapsed time if said elapsed time period is recorded for a plurality of consecutive monitored interactions.

21. The computer program product of claim 20, wherein monitoring interactions includes monitoring one or more of touches of one or more buttons or objects of the mobile electronic device, one or more swipes of a screen of the mobile electronic device, monitoring receipt of one or more motion activated commands, and receipt of one or more verbal commands.
